(19) United States
(12) Patent Application Publication
(10) Pub. No.: US 2015/0264870 A1
(43) Pub. Date: Sep. 24, 2015

(54) DECORATIVE MINIATURE GARDEN PLATE

(71) Applicant: Barbara Jean Allen, Woodbury, MN (US)

(72) Inventor: Barbara Jean Allen, Woodbury, MN (US)

(21) Appl. No.: 14/563,611

(22) Filed: Dec. 8, 2014

Related U.S. Application Data
(60) Provisional application No. 61/968,192, filed on Mar. 20, 2014.

(51) Int. Cl. A01G 9/10; A01G 9/02; A01G 9/04; A01G 7/00

(52) U.S. Cl. CPC A01G 9/102; A01G 7/00; A01G 9/02; A01G 9/04

(57) ABSTRACT

A decorative miniature garden apparatus and kit is provided. The decorative miniature garden of the present invention may at least include a plate An opening is formed through the plate and is sized to receive a plant within. The upper surface of the plate may include at least one decoration. A plant may be placed within a container and the plate may be placed within the container so that the plant is protruding through the opening.

### CROSS-REFERENCE TO RELATED APPLICATION

This application claims the benefit of priority of U.S. provisional application No. 61/968,192, filed Mar. 20, 2014, the contents of which are herein incorporated by reference.

### BACKGROUND OF THE INVENTION

The present invention relates to a miniature garden and, more particularly, to a decorative miniature garden plate.

A miniature garden is a small garden with accessories arranged in pots or containers. When a miniature garden is created, soil and stones are needed in order to make a base for the garden. Therefore, current miniature gardens are messy and the pot becomes heavy. Also, to create a well structured miniature garden, the maker must have talent, patience, and an extended period of time. Most individuals do not have the ability or the time to prepare the miniature garden.

As can be seen, there is a need for a quick and easy way to create a miniature garden.

### SUMMARY OF THE INVENTION

In one aspect of the present invention, a miniature garden apparatus comprises: a plate comprising an upper surface, a lower surface, and an outer perimeter forming an edge, wherein at least one opening is formed through the plate and is sized to receive a plant within; and at least one decoration formed on the upper surface of the plate.

In another aspect of the present invention, a miniature garden kit comprises: a plate comprising an upper surface, a lower surface, and an outer perimeter forming an edge, wherein at least one opening is formed through the plate; a container comprising a bottom, and a sidewall having an inner surface and an outer surface, wherein the plate is sized it fit within the container so that the edge of the plate rests against the inner surface, and a gap is formed between the plate and the bottom; and at least one pot comprising a bottom and a sidewall comprising an upper rim, wherein the pot is sized to fit within the gap underneath the opening of the plate.

These and other features, aspects and advantages of the present invention will become better understood with reference to the following drawings, description and claims.

### BRIEF DESCRIPTION OF THE DRAWINGS

FIG. 1 is a perspective view of a first configuration of the present invention;

FIG. 2 is an exploded perspective view of the first configuration of the present invention;

FIG. 3 is a perspective view of a second configuration of the present invention;

FIG. 4 is a perspective view of the decorative plate of the second configuration of the present invention; and

FIG. 5 is a perspective view of a third configuration of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a plate that is used with plants in a pot in order to create a decorative miniature garden. The decorative plate of the present invention fits into standard pots, and eliminates the need for soil and stones. The plates include openings in which plants may fit through. The plate may be made of various materials, such as but not limited to, ceramic, which includes glazing and firing in a kiln. A square, rectangular, round or oval, etc. shape is created with one or more holes for plants or flowers. No assembly is required except for the addition of plants or flowers. The result is a light weight, attractive and clean miniature garden.

Different plate designs may be created for different seasons and personal celebrations. For example, the plates may include a Christmas theme, a wedding theme, a golf theme, a Halloween theme, a Thanksgiving theme, an Easter theme and the like. Additionally, the present invention may be used as a table centerpiece with floral bouquets. The hole in the plate offers the flexibility of adding lighting. An instant fairy garden with a Christmas scene may be enhanced by lighting.

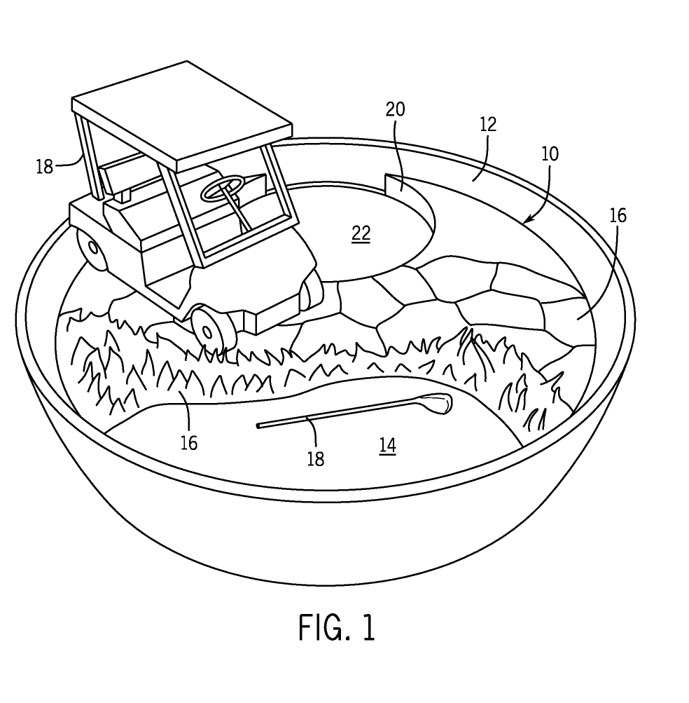

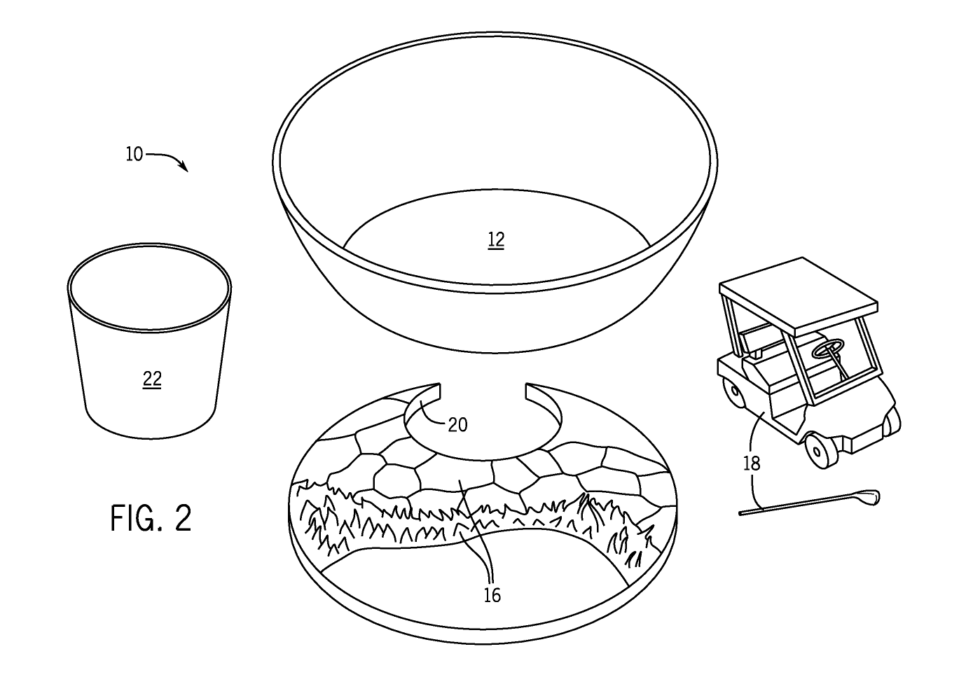

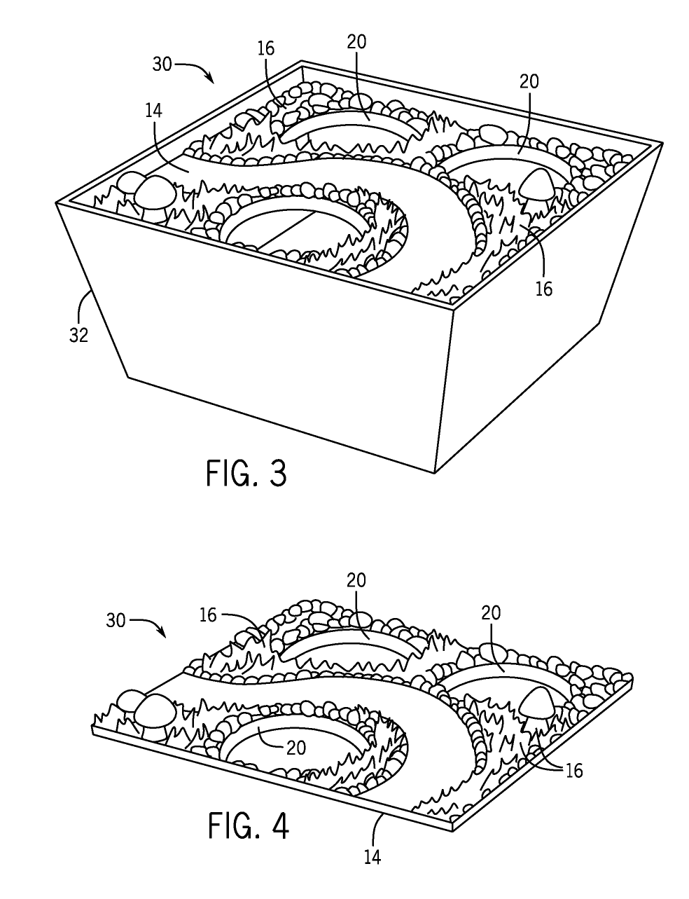

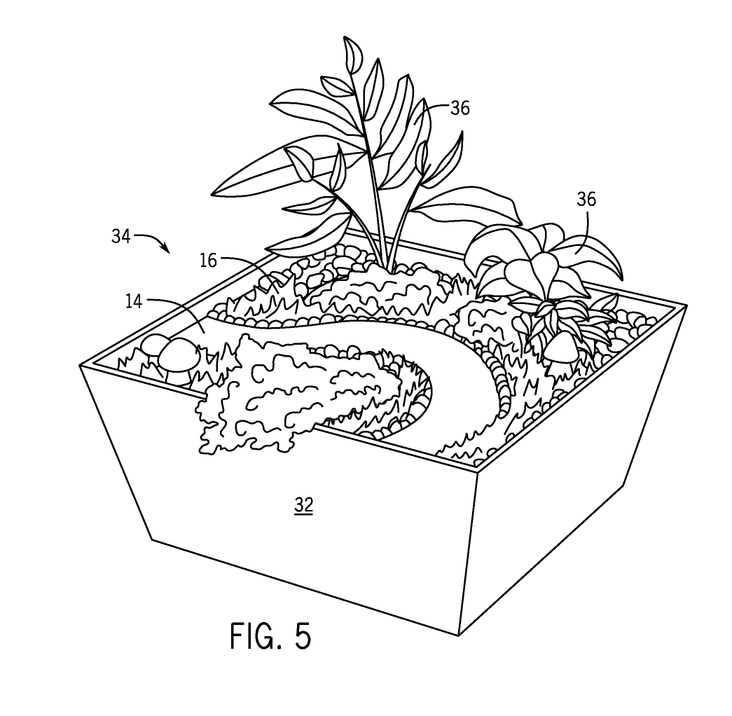

Referring to FIGS. 1 through 5, the present invention includes a decorative miniature garden apparatus and kit 10. The decorative miniature garden 10 of the present invention may at least include a plate 14 having an upper surface, a lower surface, and an outer perimeter forming an edge. An opening 20 is formed through the plate 14 and is sized to receive a plant 46 within. The upper surface of the plate 14 may include at least one decoration. A plant 46 may be placed within a container 12 and the plate 14 may be placed within the container 12 so that the plant 46 is protruding through the opening 20.

The container 12 of the present invention includes a bottom, and a sidewall having an inner surface and an outer surface. The plate 14 is sized to fit within the container 12 so that the edge of the plate 14 rests against the inner surface, and a gap is formed between the plate 14 and the bottom. The container 12 may be circular, rectangular or square shaped. The plate 14 may correspond with the container, and thereby be circular, rectangular or square shaped to fit properly within the container 12.

The present invention may further include a plant pot 22. The plant pot 22 may be sized to fit within the opening of the plate 14. Further, the plant pot is disposed in between the plate 14 and the bottom of the container 12 so that the plant 46 may protrude from the opening. The pot 22 includes a bottom and a sidewall forming an upper rim. In certain embodiments, the upper rim of the pot 22 may fit within the opening of the plate 14. The present invention may further include a plurality of pots 22. In such embodiments, the plate 14 may include a plurality of openings to receive the plants 46 within each of the pots 22.

The at least one decoration 16 of the present invention may include a plurality of decorations 16 formed on the upper surface of the plate 14. For example, the decorations 16 may include but is not limited to, a replication of at least one of soil, water, stones, sidewalks, pathways, plants, mushrooms, and sand. The decorations 16 may be painted or sculpted into the upper surface. The present invention may further include decorative accessories 18. For example, when the plate 14 mimics a golf course scene, the present invention may include miniature replica golf carts and golf clubs. Further, for Christmas settings, the decorative accessories 18 may include sleighs, and reindeer. Each of the plates 14 may be made with decorations 16 based on certain themes and optionally corresponding accessories 18.

The present invention may come in a kit 10. For example, the kit 10 may include the plate 14 with decorations 16, the corresponding container 12, and a plant pot 22 sized to fit between the plate 14 and the container bottom. Further, if there is more than one opening 22 through the plate 14, the kit 10 may come with more than one plant pot 22. Further, in alternate embodiments, the kit 10 may include different accessories 18 to place on the plate 14 after the present invention has been put together.

A method of assembling the present invention may include the following. A user may fill the pot 22 with dirt and a plant 46. The pot 22 and plant 46 may be placed within the container 12, resting on the bottom of the container 12. The plate 14 may be placed within the container 12 so that the opening 22 aligns with the pot 22 and plant 46. The accessories 18 may be placed or attached to the plate 14 and the miniature garden is complete.

It should be understood, of course, that the foregoing relates to exemplary embodiments of the invention and that modifications may be made without departing from the spirit and scope of the invention as set forth in the following claims.

What is claimed is:

1. A miniature garden apparatus comprising:
a plate comprising an upper surface, a lower surface, and an outer perimeter forming an edge, wherein at least one opening is formed through the plate and is sized to receive a plant within; and
at least one decoration formed on the upper surface of the plate.

2. The miniature garden apparatus of claim 1, wherein the at least one decoration comprises a replication of at least one of soil, water, stones, sidewalks, pathways, plants, mushrooms, and sand.

3. The miniature garden apparatus of claim 1, further comprising a container comprising a bottom, and a sidewall having an inner surface and an outer surface, wherein the plate is sized it fit within the container so that the edge of the plate rests against the inner surface, and a gap is formed between the plate and the bottom.

4. The miniature garden apparatus of claim 3, further comprising a plant pot sized to fit within the opening and disposed in between the plate and the bottom of the container.

5. The miniature garden apparatus of claim 1, wherein the at least one opening is a plurality of openings.

6. A miniature garden kit comprising:
a plate comprising an upper surface, a lower surface, and an outer perimeter forming an edge, wherein at least one opening is formed through the plate;
a container comprising a bottom, and a sidewall having an inner surface and an outer surface, wherein the plate is sized it fit within the container so that the edge of the plate rests against the inner surface, and a gap is formed between the plate and the bottom; and
at least one pot comprising a bottom and a sidewall comprising an upper rim, wherein the pot is sized to fit within the gap underneath the opening of the plate.

7. The miniature garden kit of claim 6, wherein the plate comprises at least one decoration formed on the upper surface.

8. The miniature garden kit of claim 7, wherein the at least one decoration comprises a replication of at least one of soil, water, stones, sidewalks, pathways, plants, mushrooms, and sand.

9. The miniature garden kit of claim 6, wherein the upper rim of the pot is sized to fit within the opening of the plate.

10. The miniature garden apparatus of claim 1, wherein the at least one pot is a plurality of pots and the at least one opening is a plurality of openings.
